(19) United States
(12) Patent Application Publication
(10) Pub. No.: US 2014/0320267 A1
(43) Pub. Date: Oct. 30, 2014

(54) FOOD SLICING BLADE WITH A RADIO TRANSPONDER

(71) Applicant: Weber Maschinenbau GmbH Breidenbach, Breidenbach (DE)

(72) Inventor: Guenther Weber, Gross Nemerow (DE)

(73) Assignee: Weber Maschinenbau GmbH Breidenbach, Breidenbach (DE)

(21) Appl. No.: 14/261,179

(22) Filed: Apr. 24, 2014

(30) Foreign Application Priority Data
Apr. 26, 2013 (DE) 10 2013 007 275.1

(51) Int. Cl. G06K 7/10; B26D 3/24

(52) U.S. Cl. CPC G06K 7/10009; B26D 3/24
USPC 340/10.4

(57) ABSTRACT

The present disclosure relates to a method for the use of a blade for a food slicer, where the blade comprises a radio transponder that in response to a query radio signal transmits a response data record in a response radio signal. Furthermore, a configuration signal is transmitted with a status data record. The configuration signal is received by the radio transponder, and the status data record is stored in the radio transponder. The present invention further relates to a blade for slicing food products in a food slicer, where the blade is in particular a circular blade or sickle blade, and where the blade comprises a radio transponder that is embedded in a recess in the blade. A receptacle is provided in the inner portion of the recess, where the radio transponder is disposed at least partially in the receptacle, and where the recess in the portion bordering its opening has a larger cross-section than the receptacle.

### CROSS-REFERENCE TO RELATED APPLICATIONS

This application claims priority to German Patent Application No.: 10 2013 007 275.1 filed on Apr. 26, 2013, which is hereby incorporated by reference in its entirety

### TECHNICAL FIELD

The present disclosure relates to a method for the use of a blade for a food slicer, where the blade comprises a radio transponder that in response to a query radio signal transmits a response data record in a response radio signal. The disclosure further relates to a blade for slicing food products in a food slicer, where the blade is in particular a circular blade or sickle blade, and where the blade comprises a radio transponder that is embedded in a recess in the blade.

### BACKGROUND

In food slicers, more complex cutting blades are employed due to increased machine performance. Such cutting blades are primarily designed as sickle or circular blades and can have a variety of different properties or configurations. The cutting blades can be constructed of different materials, be coated, and have different cutting patterns, for example a cutting edge with or without additionally applied cutting serrations. Furthermore, different cutting geometries can also be provided in portions of the cutting edge of the blades.

The cutting blades are used for slicing food bars, such as cheese bars, sausage bars or ham bars, or even for slicing naturally-formed food products, such as ham.

Depending on the food product to be sliced, the necessity of frequently re-sharpening blades can arise in modern slicers that have a very high cutting speed in order for it to have the required sharpness for achieving the desired cut quality. Especially with abrasive food products, such as pepper salami (pepperoni), the necessity of re-sharpening can even arise several times per day.

It is known in prior art from DE 10 2007 050 858 A1 that in a device for slicing a food product, components, and there in particular also cutting blades, exhibit a unique identification code, where it can be determined from the detected code whether the component has been installed in compliance with the selected cutting program. In this, the codes can be provided by RFID radio transponders which are attached to the components or are embedded into them.

### SUMMARY

It is the object of the present disclosure to provide a method for using a blade for food slicers and a blade for slicing food products in such a food slicer that improve the provision of blade-specific data for the food slicer.

The disclosure relates to a method for the use of a blade for a food slicer, where the blade comprises a radio transponder that in response to a query radio signal transmits a response data record in a response radio signal, the method comprising the following steps: A configuration signal with a status data record is transmitted, the configuration signal is received by the radio transponder and the status data record is stored in the radio transponder.

The configuration signal is transmitted in particular by a transceiver unit on the food slicer or a blade sharpening device.

The radio transponder is in particular an RFID transponder (Radio Frequency Identification transponder). The radio transponder can be of the passive kind, i.e. power supply is effected exclusively by an electromagnetic field to which the radio transponder is exposed. This electromagnetic field can be provided in particular by the configuration signal or the query radio signal. The response radio signal is transmitted in particular by modulation of the electro-magnetic field of the query radio signal.

Furthermore, the RFID transponder can also be of the semi-active or active kind, i.e. comprising its own power source, e.g. in the form of a battery. With an active RFID transponder, the power source can be used for generating the modulated return signal. In a semi-active RFID transponder, the power source, however, is used only for the supply of a microprocessor in the radio transponder, whereas the response radio signal is transmitted only by modulation of the query radio signal.

The query radio signal is a signal which is transmitted from a transceiver unit to the radio transponder of the blade. The transceiver unit is provided in particular on the food slicer or on a blade sharpening device and is connected to the control unit thereof.

The query radio signal can be composed of only an unmodulated electromagnetic field of a certain frequency, whereupon the radio transponder then modulates the electro-magnetic field of the query radio signal in order to transmit the response radio signal which is then received and evaluated by the transceiver unit. The response radio signal then advantageously comprises a response data record with all relevant data that is stored in the radio transponder. In other embodiments, the query radio signal can in addition to the electromagnetic field already have a modulation or a separate radio signal of a different frequency than the provided electromagnetic field. This allows a query data record to be transmitted with the query radio signal to the radio transponders, so that specific information can be queried from the radio transponder and the response data record thereby contains only the desired information. This allows communication to be more efficient and therefore faster.

The configuration signal is used to change the stored data in the radio transponder.

The status data record includes in particular specific data of the food slicer or the blade. The status data record can comprise data relating to the operation of the food slicer with a certain blade, such as the lifetime or the revolutions of the blade during the cutting operation. Furthermore, the status data record can contain information relating to the kind of product sliced by the blade. In summary, the status data record can therefore contain data for the blade usage history. Furthermore, the status data record can also contain data on the food slicer such as the type or serial number with which use of the blade can be recorded in particular for customer service applications. Furthermore, the status data record can include in particular sharpening-specific data that are within the framework of a sharpening procedure transmitted from the blade sharpening device to the blade and stored there in the radio transponder.

The response data record advantageously comprises at least parts of the status data record. A food slicer or the blade sharpening device can thereby access data that had been stored at an earlier time, e.g. by the food slicer or the blade sharpening device in the radio transponder. The operation can in particular be adapted to the corresponding data of the status data record.

The query radio signal is in particular in a frequency range of 3 MHz to 1 GHz, advantageously, in a range of 10 to 20 MHz. The query radio signal can have a frequency of e.g. 13.56 MHz. In advantageous embodiments, these frequencies allow transmission of data across an unobstructed distance of at least one meter.

The configuration signal is advantageously transmitted by a food slicer and the status data record comprises the current operating time of the blade. The respective current operating time is thereby stored continuously in the radio transponder during a slicing process, at the end of a slicing process, or when changing a blade, or added to an accumulated operating time. The operating time of the blade can then be respectively read out by a food slicer or a blade sharpening device and have influence upon the operation of the respective device. A notification in particular regarding the necessary renewed sharpening of the blade can occur or that the blade requires inspection. The current operating time of the blade can advantageously be reset in a blade sharpening device by a configuration signal after the blade has been sharpened.

In one embodiment, the configuration signal is transmitted by a blade sharpening device and the status data record comprises the number of sharpening cycles of the blade. It can thereby be determined whether the blade can still be subjected to a further sharpening cycle and whether further use of the blade in the food slicer is still possible. This allows the blade to be used until the end its life cycle, which, however, is then detected with certainty.

When the front side and the back side of the blade are sharpened separately, the number of sharpening cycles on the back side of the blade can in addition to the above-mentioned number of sharpening cycles also be transmitted in a status data record to the radio transponder and stored in the radio transponder.

In one embodiment, the status data record comprises an additional status parameter of a blade. This status parameter depends in particular on usage. The status parameter can be determined in particular by sensors on the blade sharpening device, or by reading out parameters of the control unit of the blade sharpening device, such as the position of the sharpening or dressing wheel of the blade sharpening device. A status parameter of the blade is, for example, the remaining radius that can be sharpened away which is updated in the radio transponders after each sharpening operation. It can thereby be accurately determined whether the blade can still be re-sharpened or whether the blade must be replaced by a new blade.

The response data record advantageously comprises blade-specific information regarding the sharpening process, in particular, the intended sharpening speed or rotational speed of the sharpening wheel, or the rotational speed of the dressing wheel, respectively. This information can be stored in the radio transponder in a read-only memory, since it usually does not change over the operating time of the blade. In other embodiments of the method, it is also possible, however, to transmit this information with the configuration data record status signal to the radio transponder. In addition, the blade-specific information regarding the sharpening process can change in dependency of the status parameters of the blade.

Further values, that are advantageously stored in a read-only memory in the radio transponder and can be read out with the response data record, is information relating to the identification of original products, the information whether the blade is multi-angle capable, the article number of the blade, the serial number of the blade and the date of manufacture of the blade.

Information that is transmitted primarily with the configuration signal in a status data record to the radio transponder and stored in an updated manner in the radio transponder is, for example, the machine number of the machine on which the blade was last used, or the program number of the program with which the blade was last used. This information is in particular useful in fault diagnosis by the customer service department.

In one embodiment, the response data record comprises information on the geometry of the cutting edge of the blade. This information can in particular comprise the sharpening angle and the structural design of the blade, such as a jagged, serrated structure. In particular when using multi-angle blades, i.e. blades that intermittently exhibit different cutting geometries, the sharpening angles for the respective sections as well as the section information on the angle of rotation can be stored in the radio transponder. This information relating to the multi-angle blades can be stored in a read-only memory of the radio transponder, can in other embodiments also be transmitted via the configuration signal in a status data record to the radio transponder and be stored in the radio transponder. The latter variant is particularly advantageous if the sharpening angle or the sections of the multi-angle blade are to be changed. In particular, up to four cutting sections can be provided with different sharpening angles.

Finally, a parameter can also be stored in the radio transponder regarding the radius correction of the cutting blade.

In one embodiment, the response radio signal is received by a food slicer and operation of the food slicer is controlled in dependency on the response data record. In particular, the maximum rotational speed of the blade or the maximum advance speed of the food product to be sliced can be limited by the parameters of the response data record. Furthermore, for example, operation of the food slicer can be stopped when the blade has reached its maximum service life, or when it has to be re-sharpened.

In a further embodiment, the response radio signal can be received by a blade sharpening device, where operation of the blade sharpening device is controlled in dependency of the response data record. The blade sharpening device can in particular read out the blade-specific information relating to the sharpening process and correspondingly adapt the sharpening speed or the rotational speed of the sharpening wheel and the rotational speed of the dressing wheel, respectively. In addition, the blade sharpening operation can also be performed in dependency of the parameters contained in the response data record on the geometry of the cutting edge of the blade and the desired blade geometry can thus be sharpened, e.g. a multi-blade. Furthermore, the sharpening device can determine whether further sharpening of the blade can at all still be performed in terms of the remaining radius that can be sharpened, the number of sharpening cycles of the blade, or other status parameters of the blade.

The response signal can in particular contain safety information which in combination with an entry at the blade sharpening device or the food slicer by an operator allows or prevents operation of the respective devices. An operating error can be prevented with greater certainty due to the fact that the authentication occurs in dependency of the respective blade. It can in particular be provided that only customer service staff can change the cutting blade geometry to be sharpened or sharpen a blade outside of the intended section.

A sharpening program can also be stored in the radio transponder and be transmitted in particular by the status data record to the radio transponder, and be read out using the response radio signal after clamping the blade in the blade sharpening device, thereby enabling automatic sharpening of the blade. Any operator error can thereby be prevented. The sharpening program can consist only of the specification of a sharpening angle, but can also be a full program with processing time, angle ranges in the circumferential direction of the blade, radii to be removed, and/or cutting structures.

The disclosure also provides a blade for slicing food products in a food slicer, where the blade is in particular a circular blade or sickle blade, and where the blade comprises a radio transponder which is embedded in a recess in the blade, where a receptacle is provided in the inner region of the recess, where the radio transponder is disposed at least sectionally in the receptacle, and where the recess in the portion bordering its opening has a larger cross-section than the receptacle. The receptacle thereby enables secure mounting of the radio transponder, while the larger cross-section at the opening portion of the recess improves radio communication between the radio transponder and a transceiver unit, in particular in a food slicer or in a blade sharpening device. The recess being configured in this manner allows in particular that the radio signals are not dampened or blocked by the blade made of metal before they reach the radio transponder or before they reach the transceiver unit when sent out by the radio transponder.

The recess is in particular a blind hole, advantageously configured as a stepped blind bore.

The radio embedded transponder is in particular an RFID transponder. The radio transponder is used in particular for the detection of the blade by the food slicer or a blade sharpening device. In addition to data commonly stored as read-only, such as verification data regarding an original product, article numbers, serial numbers or the date of manufacture, the radio transponder can also store and make available data regarding the blade quality, and logged data from the blade history in terms of processing and post-processing, as well as usage data relating to the use of the blade on the food slicer.

The receptacle in its cross-section in particular matches the cross-section of the radio transponder. The radio transponder can thereby be inserted in a precisely-fit manner into the receptacle so that any vibration or any slipping of the radio transponder can be excluded, even at the high centrifugal forces during operation of the blade. The radio transponder can sectionally also project from the receptacle. This can improve the quality of the radio connection to the radio transponder, especially if the antenna of the radio transponder is arranged in the projecting section. The above-mentioned cross-section of the radio transponder refers to the cross-section of the section of the radio transponder that is arranged in the receptacle. The radio transponder is nevertheless advantageously arranged entirely within the recess.

The recess is advantageous filled with a casting compound covering the radio transponder. This allows secure attachment of the radio transponder in the recess, where the casting compound still enables reliable radio communication between the radio transponder and the machine-side transceiver unit as compared with metal material of the blade. The casting compound is in particular cast resin. This cast resin is advantageously composed of two components. The cast resin exhibits little or no volume shrinkage when curing. It can also be advantageous to provide slow-curing casting compound so that no unintended premature fixation of the radio transponder in the blade occurs. This means that curing can require, for example, at least 15 minutes. Furthermore, the casting compound is approved for at least temporary food contact. The casting compound can fill the recess flush with the blade surface, but can alternatively also slightly protrude above the blade surface or be slightly recessed relative to the blade surface. To allow easy cleaning of the blade, it is advantageous if a convex or concave profile of the casting compound is provided for a protruding or recessed casting compound, respectively.

The recess advantageously comprises a back taper. This means that the recess widens at least partially when viewed in its depth direction. The back taper is in particular provided in the region of the recess that borders the opening. However, the back taper can also be provided in the inner portion of the recess, whereas certainly no back taper should be provided in the portion of the receptacle in order to enable precisely-fit insertion of the radio transponder.

The back taper allows for the casting compound covering the radio transponder not to drop out from the recess after curing, thereby providing the radio transponder in a non-detachably manner in the blade. The radio transponder can therefore not be removed from the blade, in particular not without destroying it, which also increases the blade's security against forgery.

The casting compound is in particular non-metallic bonding material. The casting compound can at least partially be formed by adhesive and sealant material completely covering the radio transponder. The hygiene requirements regarding the blade can thereby be complied with since no contamination can accumulate inside the blade in the region of the recess. The casting compound is in particular resistant to cleaning agents. Instead of using a casting compound, the radio transponder can also be only adhesively bonded to the receptacle.

The recess is in particular formed by a blind hole starting out from a front or rear of the blade.

The back taper comprises in particular a back taper of at least 1°, advantageously of at least 3°. This angle for the back taper enables secure fastening of the sealing compound and thereby of the radio transponder of the recess in the blade.

The blade comprises in particular a clamping portion contacting a blade head and a sharpened cutting edge portion, where the recess is provided between these portions. In one embodiment, the blade head has a radius of at least 150 mm, advantageously of at least 165 mm. For smaller inserted blades, the section of the cutting edge begins at a radius of 180 mm. Consequently, the radio transponder is provided mainly between the two preceding radii in the blade, i.e., in particular between a radius of 150 mm and a radius of 180 mm, preferably between a radius of 165 mm and a radius of 180 mm, and in particular at a radius of 177 mm in a specific embodiment. With a plurality of different blades, the radio transponder is advantageously always positioned at the same location so that the respective positioning of the transceiver unit on the associated food slicers or blade sharpening devices is possible. The blade head can be provided both in a food slicer as well as in a blade sharpening device. The transceiver unit is advantageously mounted stationary outside the rotating blade head on the drive housing of the blade drive.

In one embodiment, the blade is designed as a sickle blade and the radio transponder is arranged 160° to 200° in the circumferential direction, preferably about 180°, starting from the end of the cutting edge. An arrangement in a higher circumferential angle range is not advantageous since the planar section would then leave the blade, as smaller radii are provided in the starting section of the cutting edge of a sickle blade. Arrangement in a smaller angle range is not preferable since cut-outs for weight reduction are there provided in the blades that make it difficult to arrange the recess of the radio transponder.

Furthermore, the blade is in particular provided with mounting holes, in particular four mounting holes. Advantageously, the radio transponder is disposed centrally between at least two mounting holes. The stability of the blade is thereby least affected by the additional recess.

The blade is in particular always rotated in the same position before a radio connection is initiated from the food slicer or the blade sharpening device to the radio transponder. Accordingly, the disclosure is also geared towards a plurality of blades in which the radio transponder is respectively always arranged in the same position so that communication can always be achieved with a defined rotation of the blade, irrespective of the blade type or size, respectively. The blade is in particular held for two to three seconds in the predetermined position to enable radio communication with the radio transponder.

The radio transponder can in particular at least partially be formed of glass, so that it can not be removed without destruction, even if the possibly provided casting compound would were to be removed.

The back taper can also have an advantageous effect on the radio connection to the radio transponder, for example, in that the radio signal is at the back taper reflected towards the radio transponder.

In some embodiments, communication is also possible when the blade rotates. This is enabled in particular by the recess being widened so that a radio connection with the radio transponder is possible even when the radio transponder is due to the rotation of the blade disposed on the opposite side of the blade head. However, communication with the radio transponder being stationary is preferred. In other embodiments, at least the antenna of the transceiver unit can be provided on the blade head and rotate with the same. Thereby, communication is made possible when the blades are rotating.

The disclosure further provides a food slicer with a transceiver unit for communicating with a blade according to the disclosure as described above or according to a method according to the disclosure as described above. The food slicer is in particular a slicer in which one or more blade heads are provided, whereby one blade according to the disclosure is provided for each blade head. Furthermore, one transceiver unit is advantageously provided for each blade and respectively communicates with the radio transponder of the blade according to the disclosure. The response data record received by the blade via the transceiver unit of the food slicer can contain in particular information that gives release to the start of a process. This can be, in particular, the presence of a blade, verification that the blade is an original component, or a review of the necessary status parameters of the blade, such as blade sharpness, operating time, etc. Furthermore, information can be transmitted at the end of the slicing process via the configuration signal to the radio transponder and be stored therein. The usage history of the blade can thereby be stored in the radio transponder so that it can be verified, when using the blade on the same food slicer or a different food slicer, whether the blade is still suitable for continued use, whether it needs to be re-sharpened or has already reach the end of its operational capability.

The disclosure further provides a blade sharpening device with a transceiver unit for communicating with a blade according to the disclosure as described above or according to a method according to the disclosure as described above. The blade sharpening device can in particular determine the presence of a blade by communicating with the blade, can read out blade-specific information and adjust the sharpening process accordingly, or can determine the blade history of the blade in order to determine how and whether the blade can be further sharpened.

The disclosure shall below by way of example be described by embodiments which are illustrated in the following figures:

### BRIEF DESCRIPTION OF THE DRAWINGS

FIG. 1 shows a plan view of an embodiment according to the disclosure of a blade for a food slicer.

FIG. 2 shows the cross-sectional side view A-A of a section of the embodiment according to the disclosure of the cutting blade according to FIG. 1.

FIG. 3 shows an embodiment according to the disclosure of a food slicer with a blade according to the disclosure.

FIG. 4 shows a schematic side view of an embodiment according to the disclosure of a blade sharpening device with a blade according to the disclosure.

### DETAILED DESCRIPTION

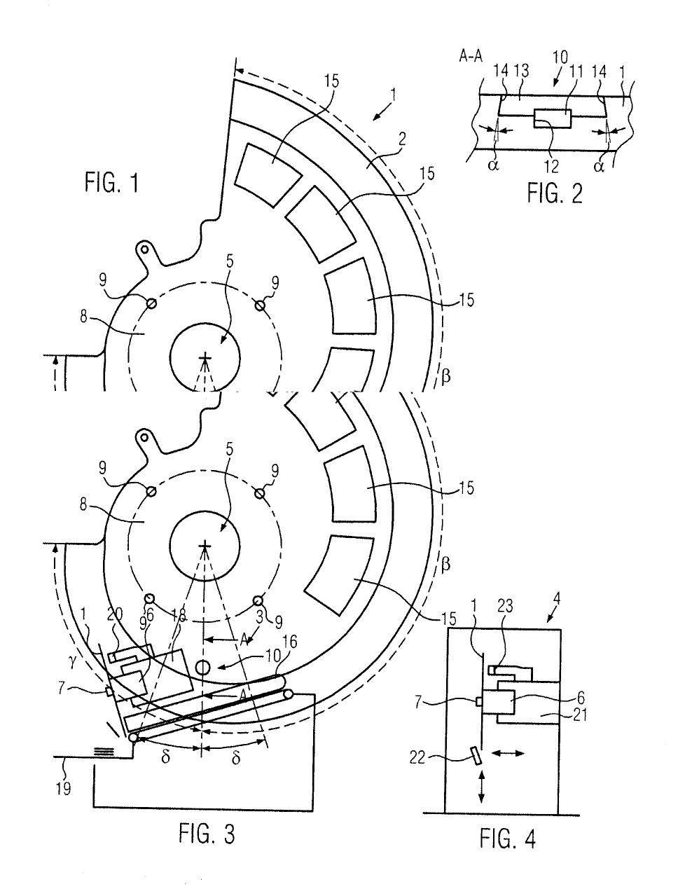

FIG. 1 shows an embodiment according to the disclosure of a blade for a food slicer, where this blade 1 is a sickle blade. The sickle blade 1 comprises a cutting edge 2 that extends over a partial section of the circumference, where the cutting edge radius, as seen in clockwise direction and in the intended rotational direction, decreases. When the blade 1 is now rotated in a food slicer 3, as shown, for example, in FIG. 3, or in a blade sharpening device 4, as shown, for example, in FIG. 4, in the clockwise direction, then the radius of the cutting edge 2 respectively increases periodically continually when view from a stationary position. This enables uniform penetration of the cutting edge 2 into a food product to be sliced. The blade comprises a mounting opening 5 with which it can be attached to a blade head 6, where in particular a projecting mounting cylinder 7 is provided on the blade head 6 in its diameter substantially corresponding to the diameter of the mounting opening 5 and is passed through the mounting opening 5.

Around the mounting opening 5, the blade 1 comprise a surface-ground section 8 abutting an abutment surface of the blade head 6. Attachment bores 9 are provided in or—as shown—on the edge of the surface-ground section 8, in particular with uniform spacing in the circumferential direction. Screws attaching the blade 1 on the blade head 6 are passed through these attachment bores 9. A recess 10 in the form of a stepped blind hole is provided centrally between the two attachment bores 9.

The recess 10 serves to attach a radio transponder 11 in the blade 1, as shown in more detail in the sectional view in FIG. 2. For this, a receptacle 12 is provided centrally in the substantially cylindrical recess 10 and is in its cross-section matched to the cross-section of the radio transponder 11. The radio transponder 11 is in particular an RFID transponder with a writeable memory.

When the radio transponder 11 is configured substantially cylindrical then the receptacle is a corresponding cylindrically shaped blind hole at the bottom of the recess 10. Due to the fact that the cross-section of the receptacle 12 is smaller than the cross-section of the recess 10, a radio connection to the radio transponder is not disturbed by the metallic portions of the blade. After the radio transponder 11 has been inserted into the receptacle 12, the recess 10 is filled with a casting compound 13 in the form of a cast resin that cures and thereby affixes the radio transponder in the blade. To prevent the casting compound 13 from dropping out or loosening, a back taper 14 is provided in the side wall of the recess 10. The back taper 14 has an angle α of at least 1 degree, and advantageously at least 3 degrees thereof with respect to the depth direction of the recess 10. Alternatively, the back taper 14 can be characterized by a saw-toothed profile on the side wall of the recess or a circumferential groove in the side wall of the recess 10.

The recess 10 is in FIG. 1 arranged at an angle β of approximately 180 degrees from the end of the cutting edge 2, where the entire cutting edge 2 extends over approximately 270 degrees of the circumference of the blade. The recess 10 is therefore disposed at an angle γ of approximately 90 degrees from the beginning of the cutting edge 2. However, the position of the recess can in some embodiments be moved by an angle δ of up to 20 degrees in the direction of the end or the beginning of the cutting edge 2. Advantageous shaping of the recess 10 is possible also in this region. In the sections further remote, however, arrangement of the recess 10 is often difficult, as either milled-out portions 15 can be provided to reduce the weight of the blade 1, or the portion between the cutting edge 2 and the surface-ground section 8 is too small. The recess is in particular arranged outside of the surface-ground section 8 for the blade head 6 so that the blade does not cover the recess 10.

FIG. 3 shows a food slicer 3 with a blade 1 according to FIG. 1. The food slicer serves to slice a food product 16 that is supplied to the rotating blade 1 on an advance device 17, in particular in the form of a conveyor belt. The blade 1, as already described above, is attached to a blade head 6 which is rotated by a drive 18. Furthermore, a tray 19 is provided behind the food slicer 3 onto which the slices or chunks of the food product cut off by the blade 1 are deposited, in particular, are stacked.

A transceiver unit 20 is stationarily provided on the food slicer 3. When the radio transponder 11 is to be read out, the blade 1 is rotated such that the recess 10 is aligned towards the transceiver unit 20, where the recess 10 is provided in the side of the blade 1 facing the transceiver unit 20. The communication process with the radio transponder 11 is executed for about 2-3 seconds, the blade 1 can then again be rotated or removed from the food slicer 3.

In particular after each cutting operation of the slicer 3, the updated operation information of the blade 1 is aggregated in a status data record and transmitted via a configuration signal from the transceiver unit 20 of the food slicer to the radio transponder 11 of the blade 1 and stored in the radio transponder 11

When the blade 1 in the food slicer 3 is replaced, then the transceiver unit 20 transmits a query radio signal to the radio transponder 11 which responds to this with a response radio signal comprising a response data record. This response data record can contain particular blade-specific information that influences operation of the food slicer.

The food slicer can therewith in particular determine whether the blade 1 is suitable for the desired use and when re-sharpening of the blade must be performed.

Re-sharpening of the blade occurs in a blade sharpening device 4 which is shown schematically in FIG. 4. The blade sharpening device 4 also comprises a respective blade head 6 onto which the blade is attached with attachment screws being provided in the attachment bores 9. The blade sharpening device 4 also comprises a drive 21 which can set the blade 1 in rotation. The blade sharpening device further comprises a sharpening element 22 with which re-sharpening of the blade 1 is effected. The sharpening element 22 can be positioned and/or rotated to obtain the desired blade geometry. The sharpening element 22 can in particular be a grinding wheel. In addition to the sharpening element, a dressing element—not shown—can also be provided.

The blade sharpening device 4 also comprises a stationarily provided transceiver unit 23 which is configured to communicate with the radio transponder 11. The radio transponder 11 can after insertion of the blade 1 in the blade sharpening device 4 be read out to determine the necessary parameters for sharpening the blade 1 and to control the blade sharpening device 4 accordingly. In particular an entire sharpening program can be stored in the radio transponder 11 with data on the respective positions of the sharpening element 22 for the respective sections of the blade edge 2. Alternatively, only the type of blade 1 can be stored in the radio transponder 11 and read out by the transceiver unit 23, and the blade sharpening device maintains information available regarding the respective sharpening parameters or downloads them from a network, respectively. According to the disclosure, a configuration signal with a status data record is transmitted by the transceiver unit 23 to the radio transponder 11 and stored in the radio transponder 11. This occurs in particular at the end of the sharpening operation. It can be stored therewith, for example, how many sharpening operations have already been performed on the blade, or how much of the radius of the blade has already been ground off during sharpening operations. This allows determining the remaining service life of the blade 1.

The recess 10 formed according to the disclosure allows that the orientation of the blade 1 does not need to be overly precise relative to the transceiver unit 20, 23, because communication with the radio transponder 11 can be effected even with a slightly offset arrangement. It is even possible in some embodiments that there needs to be no alignment between the radio transponder 11 and the transceiver unit 20, 23, since radio communication between the transceiver unit 20, 23 and the radio transponder 11 is possible irrespective of the rotational position of the blade 1 due the widening shape of the recess 10.

In some embodiments, the transceiver unit 20, 23 is movable in the radial direction of the blade. This allows the transceiver unit 20, 23 to respectively be moved to different positions of the radio transponder 11 in different of blades In some embodiments, automated movement of the transceiver unit 20, 23 is possible so that the position of the radio transponder 11 can initially be determined and the transceiver unit 20, 23 can then be moved respectively.

After the blade 1 has been inserted into the blade sharpening device 4, the blade can be rotated in particular automatically, so that the recess 10 is oriented towards the transceiver unit 23. Alternatively, the blade 1 can initially be inserted into the blade sharpening device 4 in such a position that the recess 10 and the transceiver unit 23 are oriented towards each other. The transceiver unit 23 then transmits a query radio signal to the radio transponder 11, which responds with a response radio signal containing a response data record which can comprise in particular parts of a status data record which had previously been transmitted to the radio transponder 11 and stored in the radio transponder 11. The response data record can comprise in particular information on the blade geometry, e.g. the diameter or cutting geometry. The response data record can further contain data on the sharpening history, e.g. how often the blade has been sharpened, or the current sharpening radius of the blade. This is commonly part of the status data record which was in a blade sharpening device 4 transmitted to the radio transponder 11. Furthermore, the response data record can contain information as to what extent the blade is suitable for certain food products that are to be cut.

The response data record can also contain information relating to operating time, either in total or since the last sharpening of the blade. This usually represents a part of the status data record which is in the food slicer and the blade sharpening device transmitted to the radio transponder 11. Furthermore, the response data record can contain data about the permitted rotational speed. Finally, the response data record can comprise information relating to the quantities of food products already cut with the blade, either in total or since the last sharpening of the blade. The quantity can be specified in particular by the weight of the cut food product or by the number of slices of the cut food product. Product-specific information can additionally be stored, that the abrasion properties of the food product can be considered for the possible operating life of the blade. Information relating to the quantity of the cut food product is part of a status data record which can be transmitted with a configuration signal from the transceiver unit to the radio transponder 11 in the blade after slicing a food product or prior to removing a blade from the food slicer.

1. A method for the use of a blade for a food slicer, said blade having a cutting edge, wherein said blade includes a radio transponder which, in response to a query radio signal, transmits a response data record in a response radio signal, comprising the following steps:
transmitting a configuration signal with a status data record,
said radio transponder receiving said configuration signal, and
storing said status data record in said radio transponder.

2. The method according to claim 1, where said response data record comprises at least parts of said status data record.

3. The method according to claim 1, where said query radio signal is in a frequency range of 3 MHz to 1 GHz.

4. The method according to claim 1, wherein said configuration signal is transmitted by a food slicer, and said status data record comprises current operating time of said blade.

5. The method according to claim 1, wherein said configuration signal is transmitted by a blade sharpening device, and said status data record comprises a number of sharpening cycles of said blade.

6. The method according to claim 1, wherein said configuration signal is transmitted by a blade sharpening device, and said status data record comprises a status parameter of said blade.

7. The method according to claim 1, wherein said response data record comprises blade-specific information regarding a sharpening process, including desired sharpening speed or rotational speed of a sharpening wheel or the rotational speed of the dressing wheel.

8. The method according to claim 1, where said response data record comprises information on the blade cutting edge of said geometry.

9. The method according to claim 1, wherein said response radio signal is received by a food slicer, and operation of said food slicer is controlled in dependency on said response data record.

10. The method according to claim 1, wherein said response radio signal is received by said blade sharpening device, and operation of said blade sharpening device is controlled in dependency on said response data record.

11. A blade for slicing food products in a food slicer, comprising at least one of a circular blade or sickle blade, said blade including a radio transponder that is embedded in a recess in said blade,
wherein a receptacle provided in the inner portion of said recess, said radio transponder disposed at least partially in said receptacle, said recess in a portion bordering its opening has a larger cross-section than said receptacle.

12. The blade according to claim 11, where said recess has a cross-section that corresponds to a cross-section of said radio transponder.

13. The blade according to claim 11, wherein said recess is filled with a casting compound covering said radio transponder.

14. The blade according to claim 11, wherein said recess comprises a back taper.

15. The blade according to claim 14, wherein said back taper has a back taper in a range from about 1 degree, to about 3 degrees.

16. The blade according to claim 11, wherein said blade comprises a clamping portion contacting a blade head and a sharpened cutting edge portion, and said recess is provided between said portions.

17. The blade according to claim 11, wherein said radio transponder is in the circumferential direction of said blade provided in an angle range of 160° to 200°, starting from the end of said cutting edge.

18. (canceled)

19. (canceled)

20. The method of claim 1, wherein said food slicer includes a transceiving unit, said transceiving unit communicating with said blade radio transponder.

21. The blade according to claim 11, wherein food slicer includes a transceiving unit.

22. The method according to claim 10 wherein said blade sharpening device includes a transceiving unit.

23. The blade according to claim 11 further including a blade sharpening device equipped with a transceiver unit.
